(19) United States
(12) Patent Application Publication
(10) Pub. No.: US 2019/0132354 A1
(43) Pub. Date: May 2, 2019

(54) IMAGE PROCESSING SYSTEM AND IMAGE PROCESSING UNIT FOR GENERATING ATTACK IMAGE

(71) Applicant: Preferred Networks, Inc., Tokyo (JP)

(72) Inventor: Takuya Akiba, Tokyo (JP)

(21) Appl. No.: 16/169,949

(22) Filed: Oct. 24, 2018

(30) Foreign Application Priority Data
Oct. 26, 2017 (JP) 2017-207087

(51) Int. Cl. H04L 29/06; G06F 15/18; G06K 9/46

(52) U.S. Cl. CPC H04L 63/1466; G06K 9/46; G06F 15/18

(57) ABSTRACT

An image processing system for generating an attack image includes an attack network, and a plurality of image classification networks for an attack target, each including different characteristics. The attack network generates the attack image by performing forward processing on a given image. Each of the image classification networks classifies the attack image by performing forward processing on the attack image, and calculates gradients making a classification result inaccurate by performing backward processing. The attack network performs learning by using the gradients calculated by the plurality of image classification networks.

### CROSS-REFERENCE TO RELATED APPLICATIONS

This application is based upon and claims the benefit of priority of the prior Japanese Patent Application No. 2017-207087, filed on Oct. 26, 2017, the entire contents of which are incorporated herein by reference.

### FIELD

The embodiments described herein relate to an image processing system, an image processing method, and an image processing program for generating an attack image.

### BACKGROUND

In recent years, deep learning in which machine learning is performed using multilayered neural networks has attracted attention, and for example, the use of deep learning has been put into practice in various fields such as image recognition, speech recognition, machine translation, control and detection of abnormality of an industrial robot, processing of medical information, and diagnosis of medical images.

Incidentally, for example, application of an image classification model using a neural network is expanding as image recognition for automatic driving, but it is conceivable that a malicious attacker tries to cause the model to make a wrong output. More specifically, in an automatic operation system, it is common to use an in-vehicle camera image to recognize the surrounding situation, and in that case, inaccurate recognition also causes big problems, and therefore, for example, high precision is required for recognition of pedestrians, vehicles, signals, traffic signs and the like.

Conventionally, research and development of automatic driving has been verifying the recognition accuracy of automatic operation system and safety of driving in a normal environment where no malicious attacker exists. However, in the future, when the automatic driving gradually becomes practical in real life, there is a possibility that an attacker with malicious intent based on mischief, terror, etc. may appear. For that reason, recognition function with robust classifier is indispensable for recognizing image.

Here, in order to realize a robust classifier capable of accurately recognizing (classifying) the image even when the malicious attacker attempts to cause the model to make a wrong output, for example, a method of an adversarial attack for targeting wrong classification by adding arbitrary noise to an image sample, and for such an attack, a method of a defense (Defense Against Adversarial attack) of generating a more generic and robust classifier are needed, which has become a hot research topic.

For example, similarly to network security research, research on attack methods and research on defensive methods to prevent such attacks make a set. In other words, thinking about a more powerful attack method can lead to studies, research, and development of countermeasures before a malicious person or organization executes such an attack, and therefore, attacks can be prevented beforehand, which has great social significance.

As described above, for example, as a classifier which performs image recognition for automatic driving, more versatile and robust methods against attacks conducted by malicious persons and organizations are required. Generating such a versatile and robust classifier is inextricably linked to an attack that adds arbitrary noise to an image sample and causes wrong classification so that proposing a more powerful attack method is desired.

It should be noted that the stronger attack methods required to generate versatile and robust classifiers for various attacks are not limited to those generating classifiers for image recognition in automatic driving (image classifier, image classification model, and image classification network), and are also applicable to generation of classifiers used in various fields.

By the way, in general, the attack image is generated by adding a certain noise to a given actual image. For example, changing a predetermined pixel in the actual image or sticking the actual image can also be considered as a kind of noise. However, such an approach does not produce an attack image that always has the effect of attack against arbitrary actual image, and is not satisfactory as an attack method that adding arbitrary noise to the actual image and causes wrong classification.

The present embodiments have been made in view of the above-mentioned problems, and it is an object of the present embodiments to provide an image processing system, an image processing method, and an image processing program relating to an attack method for adding arbitrary noise to an image sample to cause wrong classification in order to enable generation of more versatile and robust classifiers system.

### SUMMARY

According to an aspect of the present embodiments, there is provided an image processing system for generating an attack image including an attack network, and a plurality of image classification networks for an attack target, each including different characteristics. The attack network is configured to generate the attack image by performing forward processing on a given image.

Each of the image classification networks is configured to classify the attack image by performing forward processing on the attack image, and calculate gradients making a classification result inaccurate by performing backward processing. The attack network is configured to perform learning by using the gradients calculated by the plurality of image classification networks.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

The present invention will be understood more clearly by referring to the following accompanying drawings.

FIG. 1 is a diagram for explaining an example of an image processing system.

FIG. 2 is a diagram for explaining another example of an image processing system.

FIG. 3 is a diagram for explaining a first embodiment of an image processing system according to the present embodiments.

FIG. 4 is a diagram for explaining a third embodiment of an image processing system according to the present embodiments.

FIG. 5 is a diagram for explaining a fourth embodiment and a fifth embodiment of an image processing system according to the present embodiments.

FIG. 6 is a diagram for explaining a sixth embodiment and a seventh embodiment of an image processing system according to the present embodiments.

### DESCRIPTION OF EMBODIMENTS

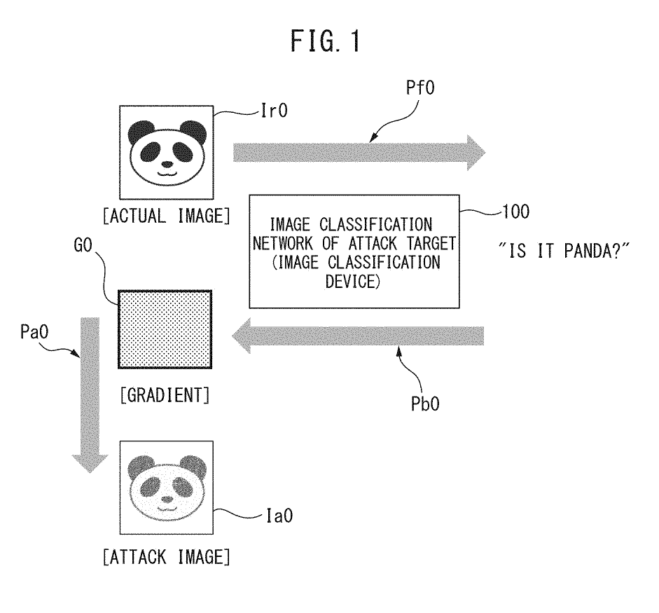

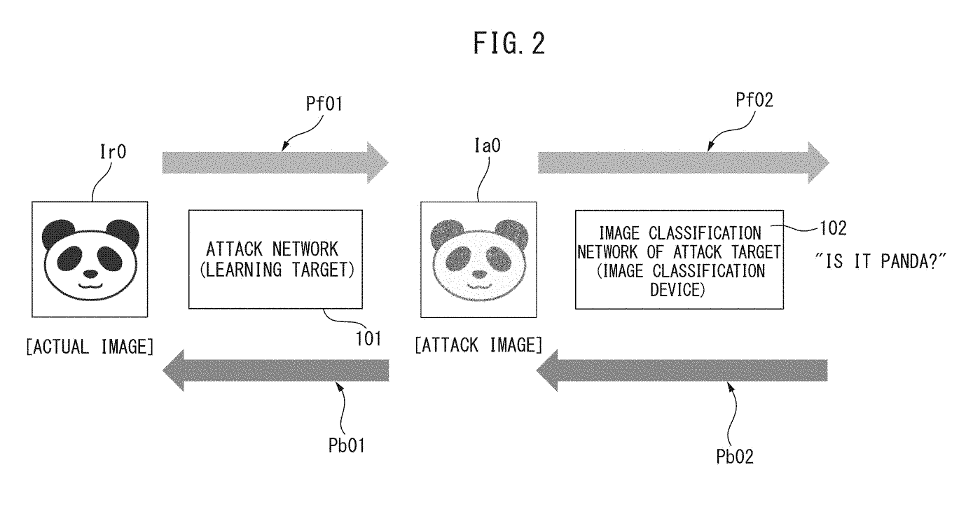

First, before embodiments of an image processing system, an image processing method, and an image processing program according to the present embodiments are explained in details, an example of an image processing system and problems associated therewith will be explained with reference to FIG. 1 and FIG. 2.

FIG. 1 is a diagram for explaining an example of an image processing system, and is for explaining an example of an image processing system for generating an attack image by adding arbitrary noise to a given actual image. In FIG. 1, reference numeral 100 denotes an image classification network (image classifier) of an attack target, Ir0 denotes an actual image, Ia0 denotes an attack image, and G0 denotes a gradient. Further, reference numeral (arrow) Pf0 denotes forward processing (processing for classifying actual image Ir0), Pb0 denotes backward processing (processing for calculating gradient (gradient in a direction of being inaccurate) G0 for making a classification result inaccurate), and Pa0 denotes processing for adding the gradient G0 obtained from the backward processing Pb0 to the actual image Ir0.

In the example of the image processing system as illustrated in FIG. 1, in a case where neural network (for example, Convolutional Neural Network (CNN)) is given as the image classification network 100, it is designed to take advantage of the mechanism of that neural network. More specifically, in Backpropagation of the image classification network 100, a gradient G0 of an input layer where classification result becomes “inaccurate” is calculated (Pb0), and an attack image Ia0 is generated by adding the gradient G0 as noise to the actual image Ir0 (Pa0). As the kind of “inaccuracy”, for example, various items such as moving away from the correct label, approaching a random label, or increasing entropy can be considered, and, with regard to the number of steps, those that perform only one step (single-step attack) or those that repeat multiple times (multi-step attack) are conceivable.

However, the image processing system (image processing method, attack method) illustrated in FIG. 1 has a problem in that access to the image classification network 100 is required also for the attack, and since the backward processing Pb0 is required every time, the calculation cost becomes high. In the image classification network (CNN) 100, there is optimization processing (optimization) in addition to the forward processing Pf0 (forward) and the backward processing Pb0 (backward) described above, but it is not directly related and is omitted.

FIG. 2 is a diagram for explaining another example of an image processing system, and is for explaining another example of an image processing system that generates an attack image Ia0 by adding arbitrary noise to a given actual image Ir0. In FIG. 2, reference numeral 101 denotes an attack network, 102 denotes an image classification network of an attack target, Pf01 and Pf02 are forward processing, and Pb01 and Pb02 denote backward processing.

In another example of the image processing system illustrated in FIG. 2, an attack network 101 for “generating” an attack image Ia0 is provided, and this attack network 101 is separately learned as a learning target. Here, the attack network 101 is a neural network which receives the actual image Ir0 and generates an attack image Ia0, and the image classification network 102 applied beforehand is applied. That is, the image classification network 102 is fixed without learning even if it receives the attack image Ia0 from the attack network 101.

The attack network 101 directly generates an attack image Ia0 obtained by adding noise to the actual image Ir0, and for example, since the attack network 101 can learn effective noise occurrence process itself (machine learning, depth learning), the attack network 101 is considered have a high degree of versatility. However, the image processing system illustrated in this FIG. 2 cannot be expected to have great effect because the method is rudimentary.

Hereinafter, the embodiments of the image processing system, the image processing method, and the image processing program according to the present embodiments will be described in detail with reference to the accompanying drawings. It should be noted that the embodiments described in detail below relate to attacks aiming for incorrect classification by adding arbitrary noise to the image sample (input image, actual image), for example, but similarly to the technical field of network security, the defense that prevents attack is to consider the countermeasure method by considering a more powerful attack method and to make it possible to prevent attacks by research and development, before a malicious human or organization executes such an attack, as described above.

Also, considering the intent of the attacker, specifying a category to be misclassified (erroneous classification) makes it possible to perform a more destructive attack, resulting in a higher degree of severity (Targeted Adversarial Attack). Specifically, in recognition of a traffic sign, for example, there is a possibility that a major problem may arise in cases such as when the sign of temporary stop is erroneously recognized as a sign with a maximum speed of 50 km.

Embodiments of an image processing system, an image processing method and an image processing program according to the present embodiments can also be used for attacks when such categories to be misidentified are specified, and this is made possible by calculating the gradient and the noise to the input layer such that the prediction result of the attack target network tilts to the category to be erroneously determined, as will be described later.

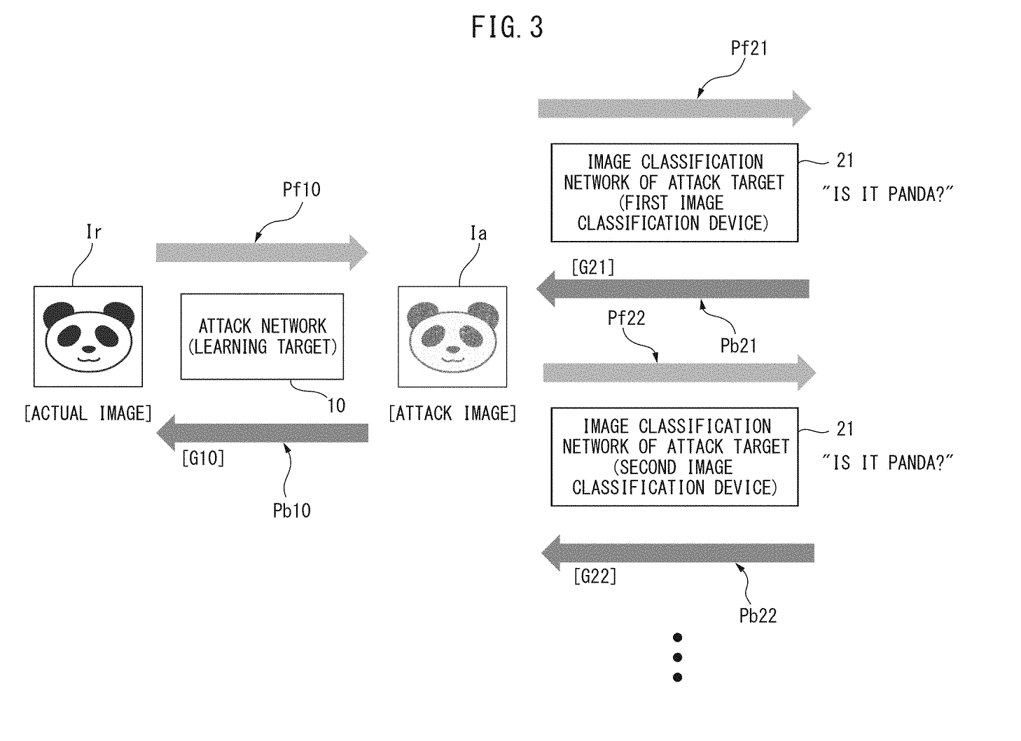

FIG. 3 is a diagram for explaining the first embodiment of the image processing system according to the present embodiments, and is for explaining the first embodiment of the image processing system which generates an attack image by adding arbitrary noise to the given actual image. In FIG. 3, reference numeral 10 denotes an attack network, reference numerals 21, 22 denote an image classification network (image classification device) of attack target, Ir denotes an actual image, and Ia denotes an attack image. Reference numerals Pf10, Pf21, Pf22 denote forward processing, and reference numerals Pb10, Pb21, Pb22 denote backward processing.

Reference numeral G10 indicates a gradient calculated by the backward processing Pb10 of the attack network 10, reference numeral G21 indicates a gradient (gradient in the direction of incorrectness) in which the classification result calculated by the backward processing Pb21 of the image classification network 21 becomes inaccurate, and reference numeral G22 indicates a gradient in which the classification result calculated by the backward processing Pb22 of the image classification network 22 becomes inaccurate.

As illustrated in FIG. 3, the attack network 10 receives the actual image Ir, generates an attack image Ia, and simultaneously gives the attack image Ia as input image for a plurality of image classification networks 21 and 22 (21, 22, . . . ). Here, the image classification network 21 and 22 is an image classification device having different characteristics, and more specifically, the image classification network (first image classification device) 21 is, for example, “Inception V3”, and the image classification network (second image classification device) 22 is, for example, “Inception ResNet V2”. It should be noted that those that have been obtained through learning in advance are applied to the image classification networks 21 and 22, and the image classification networks 21 and 2 are fixed without learning even if the image classification networks 21 and 22 receive the attack image Ia from the attack network 10.

In FIG. 3, only the image classification network 21 and 22 of two attack targets are illustrated as blocks, but three or more image classification networks may be used. More specifically, in addition to “Inception V3” and “Inception ResNet V2”, for example, various models (classification models, classification devices) having different characteristics such as “ResNet 50” and “VGG 16” can be applied as the image classification networks 21, 22, . . . .

Here, in the image processing system of the first embodiment, the classification device selected (set) as the image classification network 21, 22, . . . as the attack target, can be determined such that, for example, in the case where the classification device is actually known or predictable, the classification device can be determined based on its known or predictable classification device. Since the image processing system according to the first embodiment simultaneously gives the attack image Ia to the plurality of image classification networks 21, 22, . . . to learn the attack network 10, the image processing system according to the first embodiment can be efficiently executed in the multi-computer environment.

The attack network 10 includes forward processing Pf 10 that receives an actual image Ir and generates an attack image Ia and backward processing Pb 10 that calculates a gradient G10 based on the attack image Ia. Here, the attack image Ia is generated by using, for example, by adding the gradients (gradients in which the classification result becomes inaccurate) G21, G22, . . . calculated by the backward processing Pb 21, Pb 22, . . . of the plurality of image classification networks 21, 22, . . . , so as to be an image that is likely to induce incorrect determination caused by the plurality of image classification networks 21, 22, . . . . That is, the attack network 10 learns based on the gradient (G10+G21+G22+ . . . ) obtained by adding the gradients G21, G22, . . . to the gradient G10 to generate the attack image Ia.

As described above, the image processing system (image processing method, image processing program) according to the first embodiment sets the plurality of image classification networks 21, 22, . . . as the attack target with the single attack network 10, and accordingly, the attack network 10 learns (machine learning, depth learning) so that the loss function of all the image classification networks 21, 22, . . . becomes worse. Thus, for example, the attack image Ia which has the ability to suppress over learning for one model (one image classification network) and strongly make incorrect determination on another image classification network that was not used as an attack target can be generated. As described above, according to the first embodiment, for example, the attack network 10 which is more accurate than existing methods can be efficiently constructed, particularly in a multi-computer environment.

Next, the second embodiment of the image processing system according to the present embodiments will be explained, which is to let the attack network 10 in FIG. 3 learn a plurality of tasks. In other words, the image processing system according to the second embodiment assumes a change of, for example, the value of each pixel (red, green and blue (RGB) values) to ±ε when the attack image Ia is generated. As an example, the case where the scale ε is an integer from 4 to 16 and is given at the time of execution will be described. The reason why the value of each pixel is changed to ±ε (an integer from 4 to 16) comes from a demand for obtaining a generic attack method capable of generating an effective attack image according to not only a certain noise intensity but also an intensity of noise.

For example, in the convolution part of the attack network (eg, CNN) 10, the known image processing system outputs noise by 3 (RGB)×image size, which is multiplied by E (for example, if ε=4, 4 times, or if ε=16, 16 times) and the result is added to the image (actual image Ir), but this cannot properly generate noise that cancels the texture and cannot produce a satisfactory attack image Ia. Therefore, in order to be able to generate noise of different scales at the same time, in order to be able to generate noise for the number of channels (13: possible values of scale ε (each integer value of 4 to 16))×3×image from one attack network 10, the image processing system according to the second embodiment is configured to learn as separate tasks and make separate outputs.

For example, 13 channels corresponding to multiple scales where e are 4 to 16 are introduced, and noise of 13×3×image size (actual image Ir) is output. In this case, 13 channels are based on 13 possible values of E (each integer value of 4 to 16), i.e., 4, 5, 6, 7, 8, 9, 10, 11, 12, 13, 14, 15, and 16, which are totally 13 values. Then, the attack network 10 generates an attack image Ia using noise corresponding to externally given scale c, for example.

Thus, according to the image processing system of the second embodiment, the attack network 10 can generate the attack image Ia corresponding to the scale ε at high speed. Alternatively, according to the image processing system of the second embodiment, the attack image Ia in which the scale ε is flexibly set can be generated in a short time. When the classification device on the defending side (image classification network of the attack target) is considered, the attack network 10 can generate various attack images Ia with different scales ε at high speed and give the attack images I to the image classification network. Therefore, a more versatile and robust classification device (image classification network of attack target) can be generated in a short period of time. Therefore, a more versatile and robust classification device (image classification network of attack target) can be generated in a short period of time.

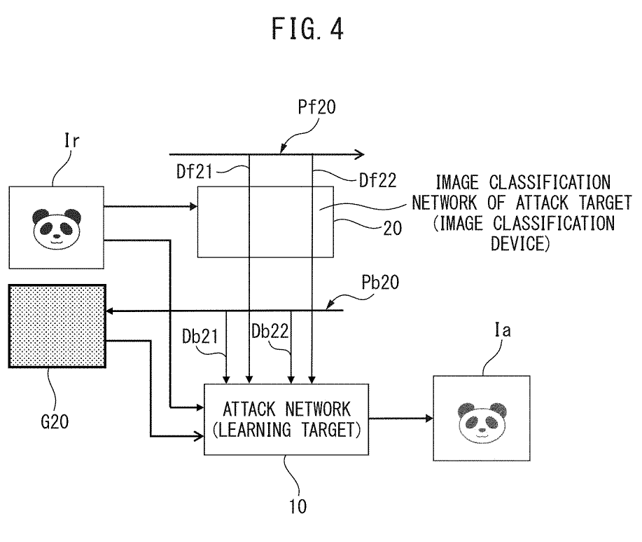

FIG. 4 is a diagram for explaining the third embodiment of the image processing system according to the present embodiments. As illustrated in FIG. 4, in the image processing system according to the third embodiment, the attack network 10 uses the gradient G20 in the image classification network 20 of the attack target to generate the attack image Ia. Here, the image classification network 20 has forward processing Pf20, backward processing Pb20, and optimization processing (optimization), but in the third embodiment, instead of performing the optimization processing, the gradients (gradients) obtained in the forward processing Pf20 and the backward processing Pb20 of the image classification network 20 and optimization (activation: state of optimization, optimization function) are output to the attack network 10.

More specifically, as illustrated in FIG. 4, in the image processing system according to the third embodiment, the attack network 10 generates the attack image Ia using gradient G20 in which the classification result obtained by backward processing Pb20 of the image classification network 20 becomes inaccurate. Further, the attack network 10 generates the attack image Ia by using the data Df21, Df22 of the gradients and activation in an intermediate layer (hidden layer) in the direction in which classification result obtained by forward processing Pf20 of the image classification network 20 becomes inaccurate and the data Db21, Db22 of the gradients and activation in which classification result obtained by backward processing Pb20 of the image classification network 20 becomes inaccurate.

Here, the neural network includes an input layer, an intermediate layer, and an output layer. However, for example, in a case where the intermediate layer of the image classification network 20 and the intermediate layer of the attack network 10 do not correspond directly, for example, processing is appropriately performed so that the data Df21, Df22, Db21, Db22 obtained from the image classification network 20 can be used by the attack network 10. More specifically, when the number of the intermediate layers of the attack network 10 is much larger than the number of the intermediate layers of the image classification network 20, for example, the data Df21, Df22, Db21, Db2 obtained from the intermediate layers of the image classification network 20 are given to the attack networks 10 for each of the plurality of intermediate layers. Thus, according to the image processing system of the third embodiment, the attack image Ia that can further make the classification result inaccurate can be generated.

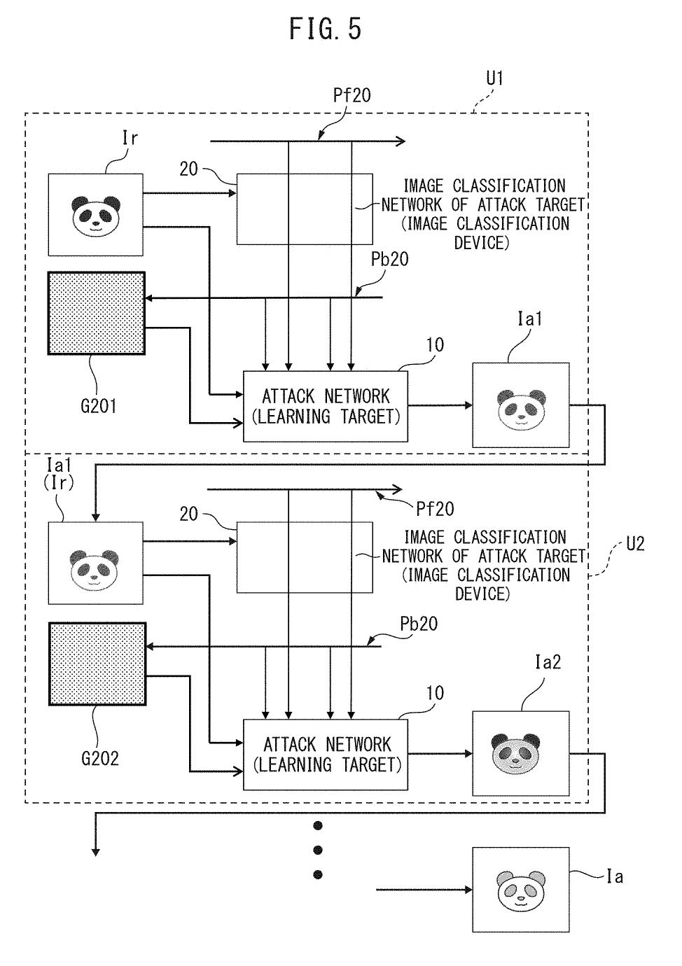

FIG. 5 is a diagram for explaining the fourth embodiment and the fifth embodiment of the image processing system according to the present embodiments. As can be seen from the comparison between FIG. 5 and FIG. 4 explained above, the image processing system according to the fourth embodiment is provided with a plurality of stages of (a plurality of sets of) image processing units U1, U2, . . . corresponding to the image processing system of the third embodiment, the image processing unit in a later stage (e.g., U2) receives the attack image Ia1 generated by the immediately preceding image processing unit (e.g., U1) as the actual image Ir to generate the additional attack image Ia2, and repeats similar processing sequentially to make the final attack image Ia.

Although the image processing system according to the fifth embodiment has the same configuration as the image processing system according to the fourth embodiment described above, the attack images Ia1, Ia2, . . . respectively generated by the image processing units U1, U2, . . . are adopted as the final attack image Ia. The image processing system according to the fifth embodiment adopts the final attack image on the basis of how the image classification network of the actual attack target reacts against the plurality of attack image candidates Ia1, Ia2, . . . respectively generated by the plurality of image processing units U1, U2, . . . and more specifically by confirming the accuracy of the classification of the image classification network.

It should be noted that the usage of the gradients G201, G202 obtained by the backward processing Pb20 of each image classification network 20 and the use of the data Df21, Df22 and Db21, Db22 of the gradients and the activation in the intermediate layer obtained by the forward processing Pf20 and the backward processing Pb20 of the image classification network 20 are similar to those explaining FIG. 4 above, and explanation thereabout is omitted.

Here, in the image processing system of the fourth embodiment and the fifth embodiment shown in FIG. 5, a plurality of image processing units U1, U2, . . . , but for example, one image processing unit (image processing system shown in FIG. 3) inputs the output attack image Ia into the attack network 10 and the image classification network 20 again as the actual image Ir to generate an attack image (Ia1) and repeats similar processing to generate the final attack image Ia. In the fourth embodiment, since it is processing for the same actual image Ir, the number of times of repeating similar processing to generate the final attack image Ia, i.e., the number of image processing units U1, U2, . . . in FIG. 5, is preferably several to several tens (several to several tens) in view of the time and the like it takes for the processing. As described above, according to the image processing system of the fourth embodiment and the fifth embodiment, it is possible to perform learning of a powerful attack network that can generate an attack image that even more strongly deceive (making incorrect determination easier) the image classification network of the actual attack target.

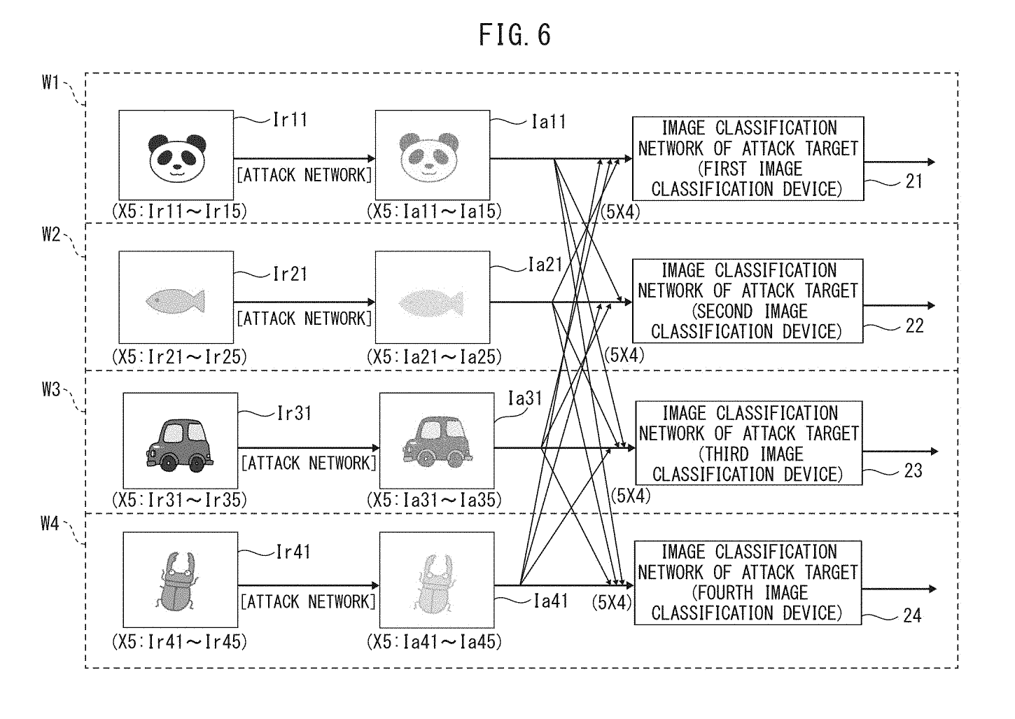

FIG. 6 is a diagram for explaining the sixth embodiment and the seventh embodiment of the image processing system according to the present embodiments, and illustrates four workers (for example, four computers operating in parallel) W1 to W4. In FIG. 6, the block of the attack network (10) for each worker W1 to W4, and the forward processing and the backward processing etc. of the attack network and the image classification networks 21 to 24, etc. are omitted. FIG. 3 above illustrates an example in which “Inception V3” is applied as the image classification network (first image classification device) 21 of the attack target and “Inception ResNet V2” is applied as the image classification network (second image classification device) 22, but in FIG. 6, further, for example, “ResNet50” is applied as the image classification network (third image classification device) 23, and “VGG16” is applied as the image classification network (fourth image classification device) 24.

By the way, when implementing the image processing system according to the present embodiments, for example, it is preferable to use a computer equipped with GPGPU (General-Purpose computing on Graphics Processing Units (or GPU)) capable of executing parallel data processing at high speed. Of course, it is also possible to use a computer equipped with an accelerator based on an FPGA (Field-Programmable Gate Array) for accelerating parallel data processing, or a computer to which a special processor dedicated to the processing of the neural network is applied, but both computers can perform parallel data processing at high speed. When using such a computer to implement the image processing system according to the present embodiments, for example, as compared to processing of attack network (10), the processing of image classification network is lighter (load is smaller, processing time is shorter), and therefore, resources can be effectively used when multiple sets of processing are performed at the same time.

More specifically, when implementing the image processing system pertaining to the present embodiments, as a precondition, both the attack network (10) and the attack target networks (21 to 24) consume large amounts of GPU (GPGPU) memory, and therefore, it is difficult to perform multi-target and the like using a single GPU or a single computer (single computer), and an environment using multiple computers (multiple computer environment) is required. Therefore, it is preferable that each attack target network of multiple targets is assigned to a different computer, the attack image generated by each computer is shared, and the number processed at one time (batch size) is changed between when used by the attack network and when used by the attack target network.

As illustrated in FIG. 6, in the image processing system according to the sixth embodiment, the system is divided into four workers W1 to W4 and the attack images Ia1 to Ia41 generated in the workers W1 to W4 are given to all the image classification networks 21 to 24 of the workers W1 to W4 in common.

More specifically, in the image processing system according to the sixth embodiment, the image classification networks 21 to 24 in the workers W1 to W4 simultaneously receive and process four different attack images Ia11 to Ia41 from the four workers W1 to W4. By parallelizing in this manner, learning efficiency can be improved.

Next, in the image processing system of the seventh embodiment, attention is given to the fact that the parallelism in the data direction and the parallelism in the model direction are independent, i.e., learning of the image classification networks (21 to 24) different from the processing of different input images (actual images Ir 11 to Ir 41) is independent, and thereby efficiency is further improved.

In the image processing system according to the sixth embodiment described above, the four attack images (attack image candidates) Ia11 to Ia41 generated by the respective workers W1 to W4 are collected and commonly given to (shared by) the image classification networks 21 to 24 with the four workers W1 to W4. In contrast, in the image processing system according to the seventh embodiment, five images are given as actual images in the workers W1 to W4. More specifically, in addition to the actual image Ir 11 of the panda, for example, the actual image Ir12 of a tiger, the actual image Ir13 of a mouse, the actual image Ir15 of a cat, and the actual image Ir 14 of a squirrel are given to the attack network of worker W1, and processing is performed in parallel. Likewise, 5 actual images Ir21 to Ir25, Ir31 to Ir35, and Ir41 to Ir45 are the worker W2, W3, and W4, respectively, to perform processing in parallel. More specifically, the attack networks of the workers W1 to W4 receive 5 actual images, perform forward processing, and each outputs 5 attack images (batch size 5).

As a result, the attack images generated by the workers W1, W2, W3, and W4 are five attack images Ia11 to Ia5, Ia21 to Ia25, Ia31 to Ia35, and Ia41 to Ia4, and the image classification networks 21 to 24 of the workers W1 to W4 process 5×4=20 attack images (Ia11 to Ia5, Ia21 to Ia25, Ia31 to Ia35 and Ia41 to Ia45) (Allgather). More specifically, each of the image classification networks 21 to 24 of the workers W1 to W4 receives 20 images and performs the forward processing and the backward processing (batch size 20). Further, the gradients are reduce-scattered, and the attack image candidates (attack images) are given to the workers W1 to W4, and the backward processing is performed in each attack network (batch size 5).

As described above, the image processing system according to the seventh embodiment has such behavior that communication is performed in the middle of computation, and the batch size changes. This is because while the attack network is quite huge and the batch size becomes quite small, whereas the attack target network is a little bit smaller, and the batch size can be increased (it is not efficient unless the batch size is increased). As described above, according to the image processing system of the sixth embodiment and the seventh embodiment, high speed and efficient processing can be realized. It should be noted that the number of workers in FIG. 6 is just an example, and the number of images given to the attack network of each worker, the configuration of the worker, etc. can be variously modified and changed.

It should be understood that the image processing system according to each embodiment described above can be provided as an image processing program or an image processing method for a computer capable of the above-described high-speed parallel data processing, for example.

In the above, the image processing system, the image processing method, and the image processing program according to the present embodiments are not limited to the application of the attack side which generates the attack image, and for example, the attack target network can be improved by using the output of the attack network, the image processing system, the image processing method, and the image processing program according to the present embodiments can also be applied to the defending side.

According to the image processing system, the image processing method, and the image processing program of the present embodiments, the proposal of the attack method which makes arbitrary noise added to an image sample to make incorrect classification achieves an effect of enabling generating of a more generic and robust classification device.

It should be understood that one or a plurality of processors may realize functions of the image processing system or the image processing unit described above by reading and executing a program stored in one or a plurality of memories.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image processing system for generating an attack image comprising:
an attack network configured to generate the attack image by performing forward processing on a given image; and
a plurality of image classification networks for an attack target, each including different characteristics and configured to classify the attack image by performing forward processing on the attack image, and calculate gradients making a classification result inaccurate by performing backward processing, wherein
the attack network is configured to perform learning by using the gradients calculated by the plurality of image classification networks.

2. The image processing system according to claim 1, wherein
the attack network is configured to perform the learning by adding the gradients calculated by the plurality of image classification networks.

3. The image processing system according to claim 1, wherein
each of the plurality of image classification networks is configured to perform learning in advance, and is fixed without learning even when each of the plurality of image classification networks receives the attack image from the attack network.

4. An image processing system for generating an attack image comprising:
an attack network configured to generate the attack image by performing forward processing on a given image; and
at least one image classification network for an attack target configured to classify the attack image by performing forward processing on the attack image, and calculate gradients making a classification result inaccurate by performing backward processing, wherein
the attack network is configured to perform learning based on possible values of a scale of each pixel of the given image, and output a plurality of noises corresponding to the possible values of the scale.

5. The image processing system according to claim 4, wherein
the attack network is configured to generate the attack image by using the noises corresponding to the possible values of the scale

6. An image processing unit for generating an attack image comprising:
an attack network configured to receive a first image and generate a second image by performing forward processing on the first image; and
an image classification network for an attack target configured to classify the first image by performing forward processing on the first image, and calculate gradients making a classification result inaccurate by performing backward processing, wherein
the attack network is configured to perform learning by using the first image and the gradients calculated by the image classification network.

7. The image processing unit according to claim 6, wherein
the attack network is configured to further perform learning by using the given image, and gradients and activations of intermediate layers making the classification results inaccurate obtained by performing the forward processing and the backward processing of the image classification network.

8. The image processing unit according to claim 6, wherein
the attack image generated by the attack network is given to the attack network and the image classification network as an image, and the attack network is configured to generate the attack image by repeatedly performing learning in a plurality of times.

9. An image processing system, including a plurality of image processing units each according to claim 6, wherein
an image processing unit of a later stage in the plurality of image processing units is configured to receive the second image generated by an immediately preceding image processing unit of the plurality of image processing units as the first image, and generate an additional second image, and
each of the image processing units of the later stage is configured to generate the attack image.

10. An image processing system, including a plurality of image processing units each according to claim 6, wherein
image processing units of later stages are configured to generate a plurality of attack image candidates, and
an image processing unit of a final stage is configured to generate a final attack image based on how the image classification network responds to the plurality of attack image candidates.

11. An image processing system, including a plurality of workers, for generating an attack image, wherein each of the plurality of workers comprises:
an attack network configured to receive a first image and generate a second image by performing forward processing on the first image; and
an image classification network for an attack target configured to classify the attack image by performing forward processing on the first image, and calculate gradients making a classification result inaccurate by performing backward processing, wherein
the attack network in each of the plurality of workers is configured to perform learning by using the first image and the gradients calculated by the image classification network, and
a plurality of images generated by the attack network in the plurality of workers are summarized, and are commonly given to the image classification network in each of the workers.
